(19) United States
(12) Patent Application Publication
(10) Pub. No.: US 2011/0173393 A1
(43) Pub. Date: Jul. 14, 2011

(54) CACHE MEMORY, MEMORY SYSTEM, AND CONTROL METHOD THEREFOR

(75) Inventor: Takanori ISONO, Kyoto (JP)

(73) Assignee: PANASONIC CORPORATION, Osaka (JP)

(21) Appl. No.: 13/069,590

(22) Filed: Mar. 23, 2011

Related U.S. Application Data
(63) Continuation of application No. PCT/JP2009/004600, filed on Sep. 15, 2009.

(30) Foreign Application Priority Data
Sep. 24, 2008 (JP) 2008-244963

(51) Int. Cl. G06F 12/08

(52) U.S. Cl. 711/122; 711/141; 711/E12.017

(57) ABSTRACT

A cache memory according to the present invention includes: a first port for input of a command from the processor; a second port for input of a command from a master other than the processor; a hit determining unit which, when a command is input to said first port or said second port, determines whether or not data corresponding to an address specified by the command is stored in said cache memory; and a first control unit which performs a process for maintaining coherency of the data stored in the cache memory and corresponding to the address specified by the command and data stored in the main memory, and outputs the input command to the main memory as a command output from the master, when the command is input to the second port and said hit determining unit determines that the data is stored in said cache memory.

### CROSS REFERENCE TO RELATED APPLICATION

This is a continuation application of PCT application No. PCT/JP2009/004600 filed on Sep. 15, 2009, designating the United States of America.

### BACKGROUND OF THE INVENTION

(1) Field of the Invention

The present invention relates to cache memories, memory systems, and control methods therefor, and particularly relates to a cache memory in which part of data stored in the main memory is stored according to an access from a processor, and a memory system including the cache memory.

(2) Description of the Related Art

In recent memory systems, a small-capacity and high-speed cache memory composed of static random access memory (SRAM), for example, is provided inside or in the proximity of a microprocessor.

In such a memory system, storing part of data read by the microprocessor from the main memory and part of data to be written on the main memory in the cache memory (cache) accelerates memory access by the microprocessor.

FIG. 14 illustrates the configuration of a conventional memory system 100. The memory system 100 illustrated in FIG. 14 includes a CPU 101, a cache memory 102, a memory controller 103, a memory 104 which is a main memory, and a direct memory access controller (DMAC) 105.

At the time of access from the CPU 101 to the memory 104, the cache memory 102 determines whether or not the data in the address of the access destination is already stored in the cache memory 102, and, when the data is stored in the cache memory (hereafter referred to as “hit”), the cache memory 102 outputs the stored data to the CPU 101 (at the time of reading), or updates the data (at the time of writing). In addition, when the data in the address of the access destination is not stored (hereafter referred to as “cache miss”), the cache memory 102 stores the address and data output from the CPU 101 (at the time of writing) or reads the data in the address from the memory 104 and stores the data, and outputs the read data to the CPU 101 (at the time of reading).

Furthermore, in the case of cache miss, the cache memory 102 determines whether or not there is empty space in the cache memory 102 for storing a new address or data, and when it is determined that there is no empty space, processes such as line replacement and writing back (purge) are performed as necessary.

Here, in the conventional memory system 100, the write data is temporarily stored in the cache memory 102 at the time of writing. This causes a case in which the data stored in the memory 104 and the data stored in the cache memory 102 are different. If the DMAC 105 accesses the memory 104 in this case, there is a problem that the coherency of the data in the CPU 101 and the DMAC 105 is not maintained.

In order to maintain the coherency, after the CPU 101 writes the data on the cache memory 102, it is necessary for the CPU 101 to instruct the cache memory 102 to perform a write-back (purge). However, the CPU 101 cannot perform the next process until the purging is complete. In other words, the processing capacity of the CPU 101 degrades.

Furthermore, in the memory system including a level 2 cache, the purging on the level 1 cache and the level 2 cache is necessary. As a result, the processing capacity of the CPU 101 degrades further.

In order to address the problem above, there is a known method in which the CPU 101 and the DMAC 105 share the cache memory 102 (See Patent Literature 1: Japanese Unexamined Patent Application Publication No. 2002-278834).

The following describes the conventional memory system 110 in which the cache memory 102 is shared.

FIG. 15 illustrates the configuration of the conventional memory system 110 in which the cache memory 102 is shared.

The memory system 110 illustrated in FIG. 15 includes a bus 106, in addition to the configuration illustrated in FIG. 14. With this configuration, when the CPU 101 and the DMAC 105 use the same data stored in the memory 104, the DMAC 105 can access the cache memory 102 through the bus 106, in the same manner as the CPU 101.

FIG. 16 illustrates an overview of the operations by the cache memory 102 in response to the access from the DMAC 105.

As illustrated in FIG. 16, at the time of reading and hit, the cache memory 102 outputs the hit data to the DMAC 105. At the time of writing and hit, the cache memory 102 updates the hit data.

At the time of reading and cache miss, the cache memory 102 reads the data from the memory 104, stores the data, and outputs the read data to the DMAC 105. Alternatively, the DMAC 105 reads the data from the memory 104. In addition, at the time of writing and cache miss, the cache memory 102 stores an address and data output from the DMAC 105. Alternatively, the DMAC 105 writes the data on the memory 104.

With the configuration described above, even if the CPU 101 updates the data in the cache memory 102, the DMAC 105 reads the data in the updated cache memory 102. Thus, the CPU 101 does not have to perform the purging. Therefore, the memory system 110 can suppress the reduction in the processing capacity of the CPU 101 while maintaining its coherency.

### SUMMARY OF THE INVENTION

However, it is necessary for the memory system 110 illustrated in FIG. 15 to include the bus 106, which increases dimensions of the memory system 110 compared to the memory system 100 illustrated in FIG. 14. This problem is even more prominent in a case where the memory system 110 includes more than one master such as the DMAC 105.

Furthermore, when more than one bus protocol is used as the protocol used for the data transmission between the DMAC 105 and the memory 104, there is a problem that interface between the DMAC and the cache memory 102 becomes more complex.

In view of the problems, it is an object of the present invention to provide a memory system and a cache memory which are capable of suppressing the reduction in the processing capacity of the processor such as the CPU in order to maintain the coherency, the increase in dimensions, and increased complexity in interface of the cache memory.

In order to achieve the abovementioned object, the cache memory according to an aspect of the present invention is a cache memory which stores part of data stored in a main memory according to an access from a processor, the cache memory including: a first port for input of a command from the processor; a second port for input of a command from a master other than the processor; a hit determining unit which, when a command is input to the first port or the second port, determines whether or not data corresponding to an address specified by the command is stored in the cache memory; and a first control unit which performs a process for maintaining coherency of the data stored in the cache memory and corresponding to the address specified by the command and data stored in the main memory, and outputs the input command to the main memory as a command output from the master, when the command is input to the second port and the hit determining unit determines that the data is stored in the cache memory.

With this configuration, when an access from the master such as the DMAC is a hit, the cache memory according to an aspect of the present invention performs processing for maintaining coherency between the hit data and the data stored in the main memory, instead of outputting the hit data to the master or updating the hit data, and outputs the command to the main memory.

With this, even when the data in the cache memory is updated by the processor such as the CPU, a process for maintaining coherency is performed by the cache memory at the time of an access from the master to the main memory. With this, in an access to the main memory by the command output by the cache memory, the coherency between the cache memory and the main memory is maintained. With this, the processor such as the CPU does not have to instruct the cache memory to perform a process for maintaining the coherency such as purging, after the writing process. As such, the cache memory according to an aspect of the present invention can reduce the purging, thereby suppressing the reduction in the processing capacity of the processor for maintaining the coherency.

Furthermore, in the cache memory according to an aspect of the present invention, even when an access from the master is a hit, it is not necessary to transmit read-data or write-data between the cache memory and the master. Thus, a bus for transmitting the read-data or the write-data between the cache memory and the master is not necessary. With this, the dimension of the memory system including the cache memory according to an aspect of the present invention can be reduced.

Furthermore, a new control for the data transmission between the master and the cache memory is not necessary, since the read-data or the write-data does not pass through the cache memory. In other words, the present invention prevents the interface between the master and the cache memory from becoming more complex.

In addition, the first control unit may include a first read control unit which, when a read-command is input to the second port as the command, the hit determining unit determines that the data is stored, and the data stored in the cache memory is dirty, writes the data back to the main memory, and outputs the input read-command to the main memory as a read-command output from the master, after the write-back is complete.

With this configuration, when the read access from the master is a hit, the cache memory according to an aspect of the present invention writes the data back to the main memory and outputs the read-command to the main memory, instead of outputting the data stored in the cache memory to the master. With this, the data in the cache memory is updated by the processor. Thus, even when the data in the cache memory and the data in the main memory do not match, the master can read the correct data (updated data). In other words, it is not necessary for the processor to instruct the cache memory to perform the purging after writing. As such, the cache memory according to an aspect of the present invention can reduce the purging, thereby suppressing the reduction in the processing capacity of the processor for maintaining the coherency.

Furthermore, in the cache memory according to an aspect of the present invention, even when the read access from the master is a hit, it is not necessary for the cache memory to output the data to the master. Thus, a bus for transmitting the read-data between the cache memory and the master is not necessary. With this, the dimension of the memory system including the cache memory according to an aspect of the present invention can be reduced.

Furthermore, since the read-data does not pass through the cache memory, a new control for a data transmission between the master and the cache memory is not necessary. In other words, the present invention prevents the interface between the master and the cache memory from becoming more complex.

In addition, when the read-command is input to the second port and the hit determining unit determines that the data is not stored, the first read control unit may output the input read-command to the main memory as a read-command output from the master.

With this configuration, even when the read access from the master is a cache miss, it is not necessary for the cache memory to output the data read from the main memory to the master. Thus, a bus for transmitting the read-data between the cache memory and the master is not necessary. With this, the dimension of the memory system including the cache memory according to an aspect of the present invention can be reduced. Furthermore, since the read-data does not pass through the cache memory, a new control for a data transmission between the master and the cache memory is not necessary. In other words, the present invention prevents the interface between the master and the cache memory to be more complex.

In addition, the memory system according to an aspect of the present invention is a memory system including the following elements: the cache memory; the processor; the master; and the main memory, in which the main memory outputs the data stored in the address specified by the read-command output from the first read control unit to the master without passing the cache memory.

With this configuration, the read data is directly output from the main memory to the master, without passing through the cache memory. Thus, a bus for transmitting the read-data between the cache memory and the master is not necessary. With this, the dimension of the memory system including the cache memory according to an aspect of the present invention can be reduced. Furthermore, an aspect of the present invention prevents the interface between the master and the cache memory to be more complex.

In addition, the cache memory may further include a second read control unit which, (i) when the read-command is input to the first port and the hit determining unit determines that the data is stored, outputs the data stored in the cache memory corresponding to the address specified by the read-command to the processor, and (ii) when the read-command is input to the first port and the hit determining unit determines that the data is not stored, reads the data from the main memory in the address specified by the read-command, stores the read data in the cache memory, and outputs the data to the processor.

With this configuration, the cache memory according to an aspect of the present invention performs processing by a regular cache memory for an access from the processor.

In addition, the memory system may further include a memory controller which arbitrates between an access from the cache memory to the main memory and an access from the master to the main memory, in which the memory controller includes: a third port for input of the read-command output from the first read control unit, and for an output of the read-data output from the main memory according to the read-command to the master; and a fourth port for input of the read-command output from the second read control unit, and for an output of the read-data output from the main memory according to the read-command to the cache memory, and the memory controller arbitrates between the read-command input to the third port and the read-command input to the fourth port, according to whether the read-command is input to the third port or the fourth port.

With this configuration, the read-command output by the cache memory according to the read access from the master is input to the third port of the memory controller, and the read-command output by the cache memory according to the read access from the processor is input to the fourth port of the memory controller. With this, even when the read-command output by the master is input to the memory controller through the cache memory, the memory controller can allocate the bandwidths to the master and the processor by a simple control including allocating the bandwidth for the master to the third port, and allocating the bandwidth for the processor to the fourth port.

In addition, the memory system may further include a selector which selects one of the read-command output by the first read control unit and the read-command output by the master, and outputs the selected read-command to the main memory, in which the main memory outputs the data stored in the address specified by the read-command output by the selector to the master without passing the cache memory.

With this configuration, when the processor and the master do not use the same data in the main memory, the master can directly access the main memory.

Furthermore, in the cache memory according to an aspect of the present invention the first control unit may include a first write control unit which, when a write-command is input to the second port as the command and the hit determining unit determines that the data is stored, invalidates the data stored in the cache memory and corresponding to the address specified by the write-command, and outputs the input write-command to the main memory as a write-command output from the master.

With this configuration, when an access from the master is a write-hit, the cache memory according to an aspect of the present invention invalidates the hit data stored in the cache memory, and outputs the write-command to the main memory. With this, the writing by the master prevents incoherency in the data in the cache memory and the data in the main memory. In other words, it is not necessary for the processor and the master to add special process (such as purging) for maintaining the coherency between the cache memory and the main memory. As such, an aspect of the present invention can suppress the reduction in the processing capacity of the processor for maintaining the coherency.

Furthermore, in the cache memory according to the present invention, the cache memory does not store the write-data even when the write access from the master is a hit. Thus, a bus for transmitting the write-data between the cache memory and the master is not necessary. With this, the dimension of the memory system including the cache memory according to an aspect of the present invention can be reduced.

Furthermore, since the write-data does not pass through the cache memory, a new control for a data transmission between the master and the cache memory is not necessary. In other words, an aspect of the present invention prevents the interface between the master and the cache memory to be more complex.

In addition, the first write control unit may, when the write-command is input to the second port and the hit determining unit determines that the data is not stored, output the input write-command to the main memory as a write-command output from the master.

With this configuration, even when the write access from the master is a cache miss, the cache memory does not store the write-data. Thus, a bus for transmitting the write-data between the cache memory and the master is not necessary. With this, the dimension of the memory system including the cache memory according to an aspect of the present invention can be reduced. Furthermore, since the write-data does not pass through the cache memory, a new control for a data transmission between the master and the cache memory is not necessary. In other words, an aspect of the present invention prevents the interface between the master and the cache memory to be more complex.

Furthermore, the memory system according to an aspect of the present invention is a memory system including the following elements: the cache memory; the processor; the master; and the main memory, in which the master outputs write-data to the main memory without passing the cache memory, and the main memory stores the write-data output by the master in the address specified by the write-command output by the first write control unit.

With this configuration, the write-data is directly output from the master to the main memory without passing through the cache memory. Thus, a bus for transmitting write-data between the cache memory and the master is not necessary. With this, the dimension of the memory system including the cache memory according to an aspect of the present invention can be reduced. Furthermore, an aspect of the present invention prevents the interface between the master and the cache memory to be more complex.

In addition, the cache memory may further include a second write control unit which, when the write-command and the write-data are input to the first port and the hit determining unit determines that the data is stored, updates the data stored in the cache memory corresponding to the address specified by the write-command to the write-data, and the second write control unit outputs a write-command and write-data for writing the updated data back to the main memory.

With this configuration, the cache memory according to an aspect of the present invention performs processing by a regular cache memory for an access from the processor.

In addition, the memory system may further include a memory controller which arbitrates between an access from the cache memory to the main memory and an access from the master to the main memory, in which the memory controller includes: a third port for input of the write-command output by the first write control unit and the write-data output by the master; and a fourth port for input of the write-command and the write-data output by the second write control unit, and the memory controller arbitrates between the write-command input to the third port and the write-command input to the fourth port, according to whether the write-command is input to the third port or the fourth port.

With this configuration, the write-command output by the cache memory according to a write access from the master is input to the third port of the memory controller, and the write-command output by the cache memory according to the write access from the processor is input to the fourth port of the memory controller. With this, even when the write-command output by the master is input to the memory controller through the cache memory, the memory controller can allocate the bandwidths to the master and the processor by a simple control including allocating the bandwidth for the master to the third port, and allocating the bandwidth for the processor to the fourth port.

In addition, the memory system may further include a selector which selects one of the write-command output by the first write control unit and the write-command output by the master, and outputs the selected write-command to the main memory, in which the main memory stores the write-data output by the master in the address specified by the write-command output by the selector.

With this configuration, when the processor and the master do not use the same data in the main memory, the master can directly access the main memory.

In addition, the processor may include a level 1 cache, and the cache memory may be a level 2 cache.

With this configuration, the cache memory according to an aspect of the present invention is applied to the level 2 cache. Here, the effect of the level 2 cache on the entire memory system is smaller than the effect of the level 1 cache. More specifically, the access at the time of hit in the level 1 cache is the fastest access for the processor. Thus, the access from the master to the level 1 cache has an adverse effect on the access by the processor to the level 1 cache, which is most effective for accelerating the access. Thus, applying the cache memory according to an aspect of the present invention to the level 2 cache reduces the adverse effect on the acceleration of the processor, compared to a case where the cache memory according to as aspect of the present invention is applied to the level 1 cache.

In addition, the memory system may further include a plurality of processors including the processor, in which each of the plurality of processors includes a level 1 cache, and the cache memory is shared by the plurality of processors.

With this configuration, the cache memory according to an aspect of the present invention is applied to a level 2 cache shared by the processors. Here, when the level 2 cache is shared by the processors, it is necessary for the processors to perform a control based on an algorithm such as the cache snooping for maintaining the coherency between the level 1 caches and the level 2 cache. Thus, adding the control for maintaining the coherency between the level 2 cache and the main memory. As a result, this control makes the control even more complex and hard to implement. In order to address this problem, using the cache memory according to an aspect of the present invention to the level 2 cache reduces the process for maintaining the coherency between the level 2 cache and the main memory, thereby avoiding the control to become complex.

Furthermore, the present invention may not only be implemented as the cache memory and the memory system, but also as a control method of the cache memory or a control method of the memory system including characteristic means included in the cache memory and the memory system as steps, and also as a program causing a computer to execute the characteristic steps. Needless to say, such a program can be distributed via recording media such as CD-ROM and the transmission media such as the Internet.

Furthermore, the present invention can also be implemented as a semiconductor integrated circuit including part of or all of functions of the cache memory and the memory system.

With the configuration described above, the present invention provides a memory system and a cache memory, which are capable of suppressing the reduction in the processing capacity of the CPU in order to maintain coherency, the increase in dimensions, and increased complexity in the interface of the cache memory.

### FURTHER INFORMATION ABOUT TECHNICAL BACKGROUND TO THIS APPLICATION

The disclosure of Japanese Patent Application No. 2008-244963 filed on Sep. 24, 2008 including specification, drawings and claims is incorporated herein by reference in its entirety.

The disclosure of PCT application No. PCT/JP2009/004600 filed on Sep. 15, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram illustrating the configuration of the memory system according to an embodiment of the present invention;

FIG. 2 is a block diagram illustrating the configuration of the cache memory according to an embodiment of the present invention;

FIG. 3 illustrates the configuration of a cache storage unit and a hit determining unit according to an embodiment of the present invention;

FIG. 4 illustrates the configuration of a way according to an embodiment of the present invention;

FIG. 5 illustrates connections in the memory system according to an embodiment of the present invention;

FIG. 6 illustrates an overview of the operation in the cache memory according to an embodiment of the present invention in response to an access from DMAC;

FIG. 7 illustrates a flow of operations in the memory system according to an embodiment of the present invention at the time of read-hit;

FIG. 8 illustrates a flow of operations in the memory system according to an embodiment of the present invention at the time of read-miss;

FIG. 9 illustrates a flow of operations in the memory system according to an embodiment of the present invention at the time of write-hit;

FIG. 10 illustrates a flow of operations in the memory system according to an embodiment of the present invention at the time of write-miss;

FIG. 11 is a flowchart illustrating operations at the time of reading in the cache memory according to an embodiment of the present invention;

FIG. 12 is a flowchart illustrating operations at the time of writing in the cache memory according to an embodiment of the present invention;

FIG. 13 is a block diagram illustrating the configuration of a variation of the memory system according to an embodiment of the present invention;

FIG. 14 is a block diagram illustrating the configuration of a conventional memory system;

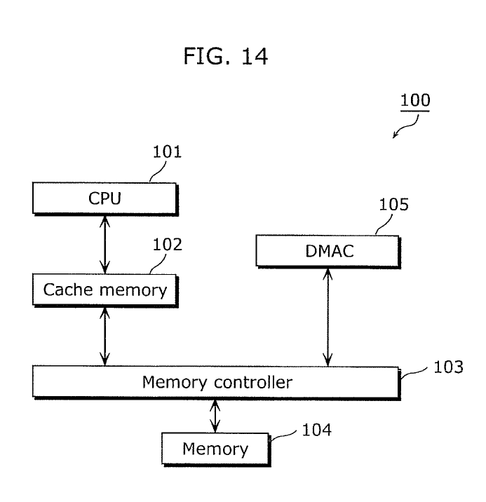

FIG. 15 is a block diagram illustrating the configuration of a conventional memory system; and

FIG. 16 illustrates an overview of the operation in the conventional cache memory in response to an access from DMAC.

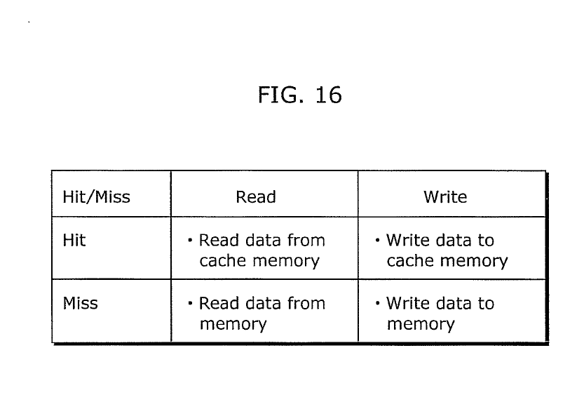

### DESCRIPTION OF THE PREFERRED EMBODIMENT

The following specifically describes an embodiment of the cache memory according to the present invention with reference to the drawings.

When a read-access from a master such as DMAC is a hit, the cache memory according to the present invention writes the hit data back to the main memory, and subsequently outputs a read-command to the main memory. In addition, when a write access from the master is a hit, the cache memory invalidates the hit data, and outputs a write-command to the main memory.

With this, the coherency between the cache memory and the main memory is maintained without a purging by the processor such as a CPU and the master. Thus, the cache memory according to an embodiment of the present invention suppresses the reduction in the processing capacity of the processor for maintaining the coherency between the cache memory and the main memory.

Furthermore, the read data and the write data are directly transmitted between the master and the main memory without passing the cache memory. With this, a bus for transmitting the read data and the write-data between the cache memory and the master is not necessary, thereby reducing dimensions of the memory system, and suppressing increased complexity in the interface between the master and the cache memory.

First, the configuration of the memory system including the cache memory according to an embodiment of the present invention shall be described.

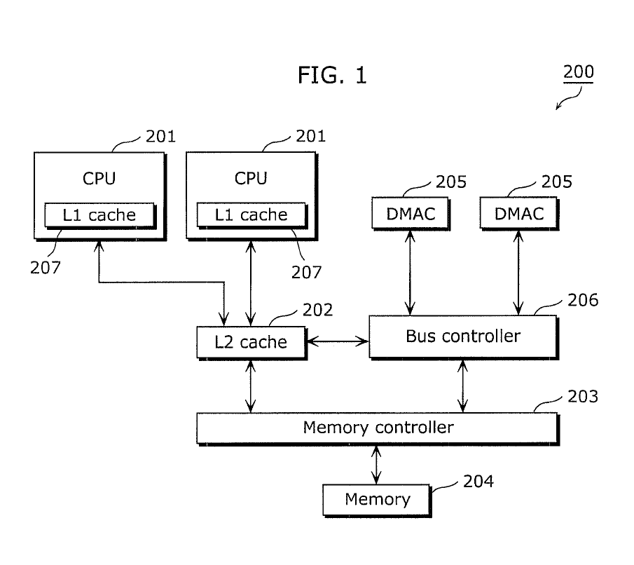

FIG. 1 illustrates the configuration of the memory system according to an embodiment of the present invention.

The memory system 200 illustrated in FIG. 1 includes two CPUs 201, an L2 (level 2) cache 202, a memory controller 203, a memory 204, two DMACs 205, and a bus controller 206. In addition, each of the CPUs 201 includes a L1 (level 1) cache 207.

The L1 cache 207 and the L2 cache 202 are high-speed and small-capacity cache memories compared to the memory 204. For example, the L1 cache 207 and the L2 cache 202 are SRAMs. Note that, the L1 cache 207 may be arranged closer to the CPU 201 than the L2 cache 202, and may be arranged outside of the CPU 201.

The L1 cache 207 and the L2 cache 202 performs what is known as a cache operation, which refers to storing part of data read from the memory 204 by the CPU 201, and part of data to be written on the memory 204. Here, caching is an operation which includes the following processes: when the CPU 201 accesses the memory 204, the L2 cache 202 determines whether or not the data in the address of the access destination is stored in the L2 cache 202, and when the L2 cache 202 stores the data (hit), the L2 cache 202 outputs the stored data to the CPU 201 (at the time of reading), or updates the data (at the time of writing). Furthermore, when the data in the address of the access destination (cache miss) is not stored in the L2 cache 202, the L2 cache 202 stores the address and data output from the CPU 201 (at the time of writing), or reads the data in the address from the memory 2 and outputs the read data to the processor 1 (at the time of reading).

Furthermore, in the case of cache miss, the L1 cache 207 and the L2 cache 202 determine whether or not there is empty space in the L1 cache 207 or the L2 cache 202 for storing a new address or data, and when it is determined that there is no empty space, processes such as line replacement or writing back (purging) are performed as necessary.

In addition, the L2 cache 202 is shared by the two CPUs 201. The memory controller 203 is an interface of the memory 204 which arbitrates an access from the L2 cache to the memory 204, and accesses from the DMACs 205 to the memory 204.

The memory 204 is a large-capacity main memory such as SDRAM.

The DMAC 205 is a master which transfers data between external devices (external devices and external memories) and the memory 204.

The bus controller 206 outputs the command output by the DMAC 205 to the L2 cache 202 or the memory controller 203. In addition, the bus controller 206 outputs the command output by the

L2 cache 202 to the memory controller 203. The bus controller 206 also outputs, write-data output by the DMAC 205 to the memory controller 203 without passing the L2 cache 202, and outputs the read data output by the memory controller 203 to the DMAC 205 without passing the L2 cache 202.

Here, the command includes information specifying a data-write or a data-read, and information indicating an address of the access destination. In addition, the write-data is data to be written on the memory 204, and the read-data is data read from the memory 204 or data stored in the L2 cache 202. In addition, the command for instructing a data-write is referred to as a write-command, and the command for instructing a data-read is referred to as a read-command. Furthermore, the write-command and the read-command are simply referred to as “command”.

The components illustrated in FIG. 1 are typically implemented as LSI which is an integrated circuit. The components may be individually implemented into single chips, or integrated into one chip including a part of or all of the components. Each of the components may be implemented as more than one chip.

The following describes an example in which the cache memory according to the present invention is applied to the L2 cache 202.

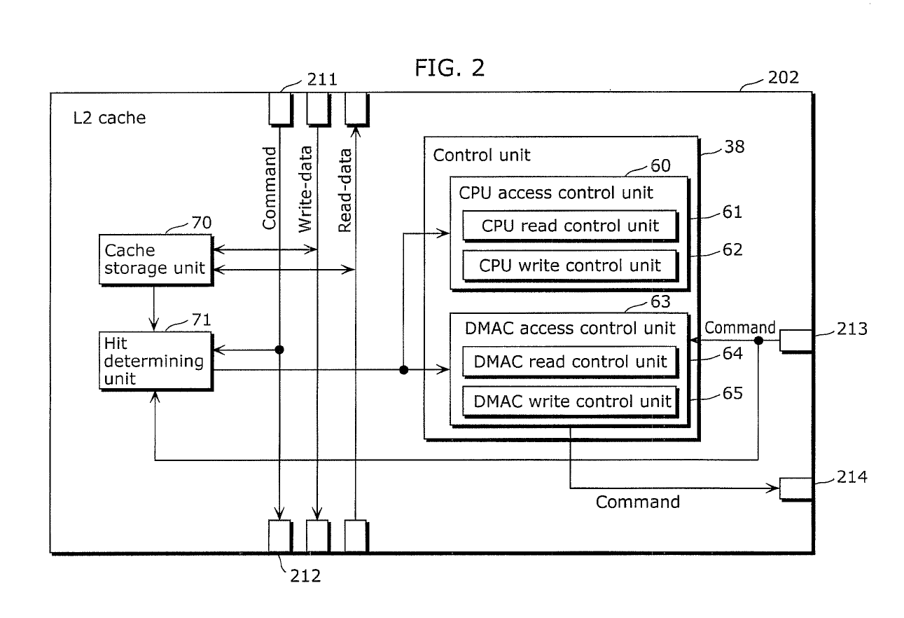

FIG. 2 is a block diagram illustrating the functional configuration of the L2 cache 202.

As illustrated in FIG. 2, the L2 cache 202 includes a control unit 38, a cache storage unit 70, a hit determining unit 71, a first port 211, a second port 212, a third port 213, and a fourth port 214.

The first port 211 is connected to the CPU 201, receives input of a command and write-data output from the CPU 201, and outputs read-data to the CPU 201.

The second port 212 is connected to the memory controller 203, and receives an input of the read data output by the memory controller 203, and outputs the command and the write-data to the memory controller 203. In other words, the second port 212 receives an input of the read data from the memory 204, and outputs the command and the write-data to the memory 204.

The third port 213 is connected to the bus controller 206, and receives an input of the command output from the bus controller 206. In other words, the third port 213 receives an input of the command output from the DMAC 205.

The fourth port 214 is connected to the bus controller 206, and outputs a command to the bus controller 206. To put it differently, the fourth port 214 outputs a command to the memory 204.

The cache storage unit 70 stores the data stored in the memory 204 to which the CPU has accessed.

The hit determining unit 71 determines, when an input of a command is received from the CPU 201 and the DMAC 205, whether the cache storage unit 70 stores the data in the address specified by the command (hit) or not (cache miss).

The control unit 38 controls the entire L2 cache 202. More specifically, the control unit 38 controls what is known as the cache operations which includes the CPU 201 storing part of the data read from the memory 204 and part of the data to be written on the memory 204. In addition, the control unit 38 performs different processing depending on whether the access is from the CPU 201 or from the DMAC 205.

The control unit 38 includes a CPU access control unit 60 which controls operations of the L2 cache 202 in response to the access from the CPU 201, and a DMAC access control unit 63 which controls operations of the L2 cache 202 in response to the access from the DMAC 205.

The CPU access control unit 60 includes a CPU read control unit 61 which controls operations of the L2 cache 202 in response to the read-access from the CPU 201, and a CPU write control unit 62 which controls operations of the L2 cache 202 in response to the write-access from the CPU 201.

When the read-command from the CPU 201 to the memory 204 is input to the first port 211 and the hit determining unit 71 determines it as a hit, the CPU read control unit 61 outputs the hit data from the first port 211 to the CPU 201. Furthermore, when the read-command from the CPU 201 to the memory 204 is input to the first port 211 and the hit determining unit 71 determines it as a cache miss, the CPU read control unit 61 reads, from the memory 204 through the second port 212, data in an address specified by the input read-command, stores the read data in the cache storage unit 70, and outputs the read data to the CPU 201 through the first port 211.

When the write-command to the memory 204 is input from the CPU 201 to the first port 211 and the hit determining unit 71 determines it as a hit, the CPU write control unit 62 updates the hit data to the write-data input from the CPU 201. When the write-command to the memory 204 is input from the CPU 201 to the first port 211 and the hit determining unit 71 determines it as a cache miss, the CPU write control unit 62 stores new write-data in the cache storage unit 70. The CPU write control unit 62 also outputs, from the second port 212 to the memory 204, the write-command and the write-data for writing the data stored in the cache storage unit 70 on the memory 204. To put it differently, the CPU write control unit 62 writes the updated write-data back to the memory 204 according to an instruction from the CPU 201 or at a predetermined timing (write-back).

When the command is input to the third port 213 from the DMAC 205, and the hit determining unit 71 determines it as a hit, the DMAC access control unit 63 performs processing for maintaining the coherency between the hit data and the data stored in the memory 204, and outputs the command input to the third port 213 to the memory 204 through the fourth port 214, as a command output from the DMAC 205. In addition, when the command is input to the third port 213 from the DMAC 205 and the hit determining unit 71 determines it as a cache miss, the DMAC access control unit 63 outputs the command input to the third port 213 to the memory 204 through the fourth port 214 as a command output from the DMAC 205.

The DMAC access control unit 63 includes a DMAC read control unit 64 which controls operations of the L2 cache 202 in response to the read-access from the DMAC 205, and a DMAC write control unit 65 which controls operations of the L2 cache 202 in response to the write-access from the DMAC 205.

When the read-command from the DMAC 205 to the memory 204 is input to the third port 213 and the hit determining unit 71 determines it as a hit, the DMAC read control unit 64 writes the hit data back to the memory 204 through the second port 212, and the read-command input to the third port 213 is output to the memory 204 through the fourth port 214, as a command output from the DMAC, after the write-back is complete.

In addition, when the read-command from the DMAC 205 to the memory 204 is input to the third port 213, and the hit determining unit 71 determines it as a cache miss, the DMAC read control unit 64 outputs, from the fourth port 214 to the memory 204, the read-command output input to the third port 213 as the read-command output from the DMAC 205.

When the write-command from the DMAC 205 to the memory 204 is input to the third port 213, and the hit determining unit 71 determines it as a hit, the DMAC write control unit 65 invalidates the hit data, and outputs, to the memory 204 through the fourth port 214, the write-command input to the third port 213 as the write-command output from the DMAC 205.

In addition, when the write-command from the DMAC 205 to the memory 204 is input to the third port 213, and the hit determining unit 71 determines it as a cache miss, the DMAC write control unit 65 outputs the write-command input to the third port 213 to the memory 204 through the fourth port 214, as the write-command output from the DMAC 205.

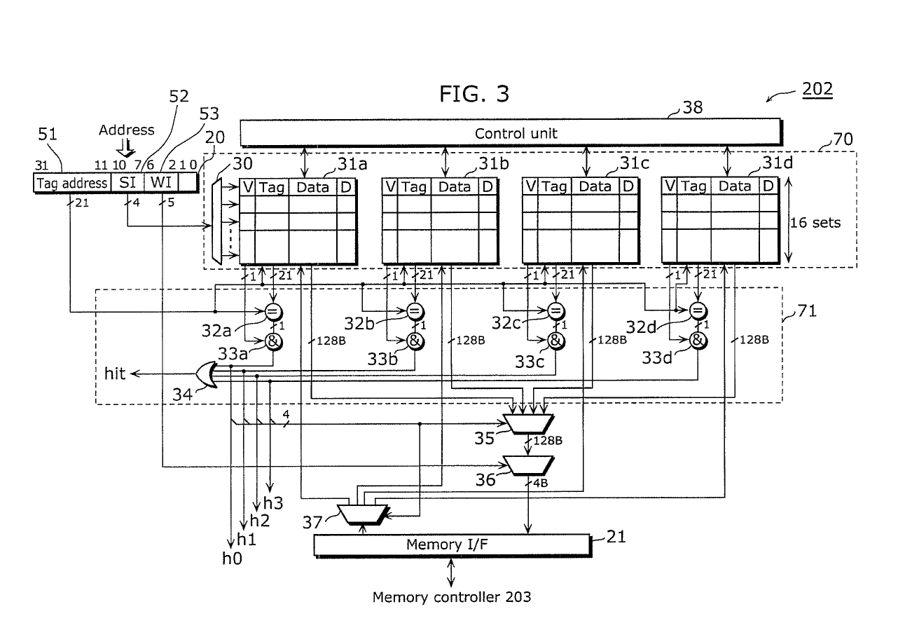

FIG. 3 is a block diagram illustrating an exemplary configuration of the cache storage unit 70 and the hit determining unit 71. In addition, as a specific example of the L2 cache 202; a configuration in which the present invention is applied to a 4-way set associative cache memory shall be described. As illustrated in FIG. 3, the cache storage unit 70 includes a decoder 30 and four ways 31a to 31d. Note that, each of the four ways 31a to 31d are also referred to as a way 31 when no specific distinction is necessary.

The hit determining unit 71 includes four comparators 32a to 32d, four AND circuits 33a to 33d, and an OR circuit 34. In addition, the L2 cache 202 further includes an address register 20, a memory I/F 21, selectors 35 and 36, and a demultiplexer 37.

The address register 20 is a register which holds an access address to the memory 204. It is assumed that the access address is 32 bits. As illustrated in FIG. 3, the access address includes a 21-bit tag address 51, a 4-bit set index (SI) 52, and a 5-bit word index (WI) 53 in this order from the most significant bit.

Here, the tag address 51 specifies an area in the memory 204 mapped on the way 31 (the size of the area is a set count X block). The size of the area is a size determined by the address bits lower than the tag address 51 (A10 to A0), that is, 2 k bytes, and is also a size of one way 31.

The set index 52 specifies one of the sets over the ways 31a to 31b. Since the set index 52 is 4 bits, the set count is 16 sets. The cache entry specified by the tag address 51 and the set index 52 is a unit for replacement, and is referred to as line data or a line when stored in the cache memory. The size of the line data is a size determined by the address bits lower than the set index 52 (A6 to A0), that is, 128 bytes. When one word is four bytes, one line data is 32 words.

The word index (WI) 53 specifies one word among words composing the line data. In addition, two least significant bits (A1, A0) in the address register 20 are ignored at the time of word access.

The memory I/F 21 is an interface for accessing the memory 204 from the L2 cache 202. More specifically, the memory I/F 21 writes data from the L2 cache 202 back to the memory 204, and loads the data from the memory 204 to the L2 cache 202.

The decoder 30 decodes 4 bits in the set index 52, and selects one of 16 sets over the four ways 31a to 31d.

The four ways 31a to 31d have the same configuration, and each way 31 has a capacity of 2 k bytes.

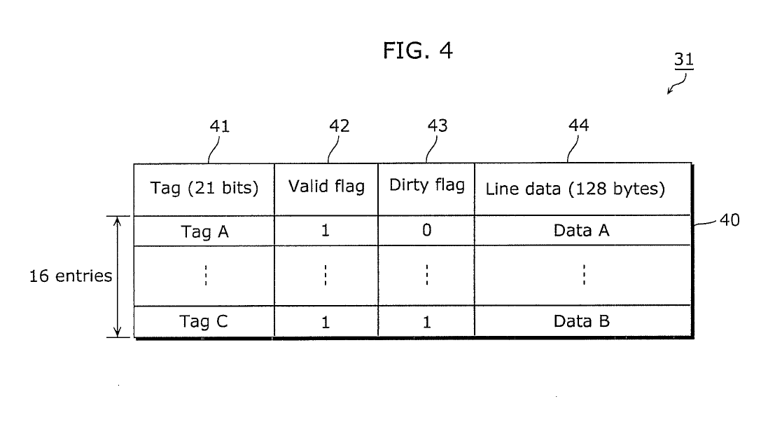

FIG. 4 illustrates the configuration of the way 31. As illustrated in FIG. 4, each way 31 has 16 cache entries 40. Each cache entry 40 includes 21-bit tag 41, a valid flag 42, a dirty flag 43, and a 128-byte line data 44.

The tag 41 is part of the address on the memory 204, and is a copy of the 21-bit tag address 51.

The line data 44 is a copy of 128-byte data in the block specified by the tag address 51 and the set index 52.

The valid flag 42 indicates whether or not the data of the cache entry 40 is valid. For example, when the data is valid, the valid flag 42 is “1”, and when the data is invalid, the valid flag 42 is “0”. Switching the valid flag 42 to “0” is also referred to as invalidating the data.

The dirty flag 43 indicates whether or not the CPU 201 has written on the cache entry 40; that is, whether or not the line data 44 has been updated. In other words, the dirty flag 43 indicates whether or not writing back the line data 44 to the memory 204 is necessary, when there is the cached line data 44 in the cache entry 40 but the line data 44 differs from the data in the memory 204 due to the writing by the CPU 201. For example, when the line data 44 has been updated, the dirty flag 43 is “1”, and when the line data 44 has not been updated, the dirty flag 43 is “0”. Changing the dirty flag 43 to “1” is also referred to as setting the dirty flag. In addition, when the dirty flag 43 is “1”, it is also referred to as the data being dirty.

The comparator 32a compares whether or not the tag address 51 in the address register 20 and the tag 41 in the way 31a in the four tags 41 included in the set selected by the set index 52 match. The same description applies to the comparators 32b to 32d, except that they correspond to the ways 31b to 31d, respectively.

The AND circuit 33a compares whether or not the valid flag 42 and the comparison result by the comparator 32a match. The comparison result is referred to as h0. When the comparison result h0 is 1, it indicates that there is line data 44 corresponding to the tag address 51 and the set index 52 in the address register 20, that is, there is a hit in the way 31a. When the comparison result h0 is 0, it indicates a cache miss. The same description applies to the AND circuits 33b to 33d, except that they correspond to the ways 31b to 31d, respectively. In other words, comparison results h1 to h3 indicate whether there is a hit or miss in the ways 31b to 31d.

The OR circuit 34 calculates OR of the comparison results h0 to h3. The results of OR is referred to as hit. Hit indicates whether or not there is a hit in the cache memory.

The selector 35 selects the line data 44 in the way 31 which is a hit, among the line data 44 in the way 31a to 31d in the selected set.

The selector 36 selects one word indicated by the word index 53 in the 32-word line data 44 selected by the selector 35.

The demultiplexer 37 outputs write data to one of the ways 31a to 31d when writing the data on the cache entry 40. The write data may be output per word.

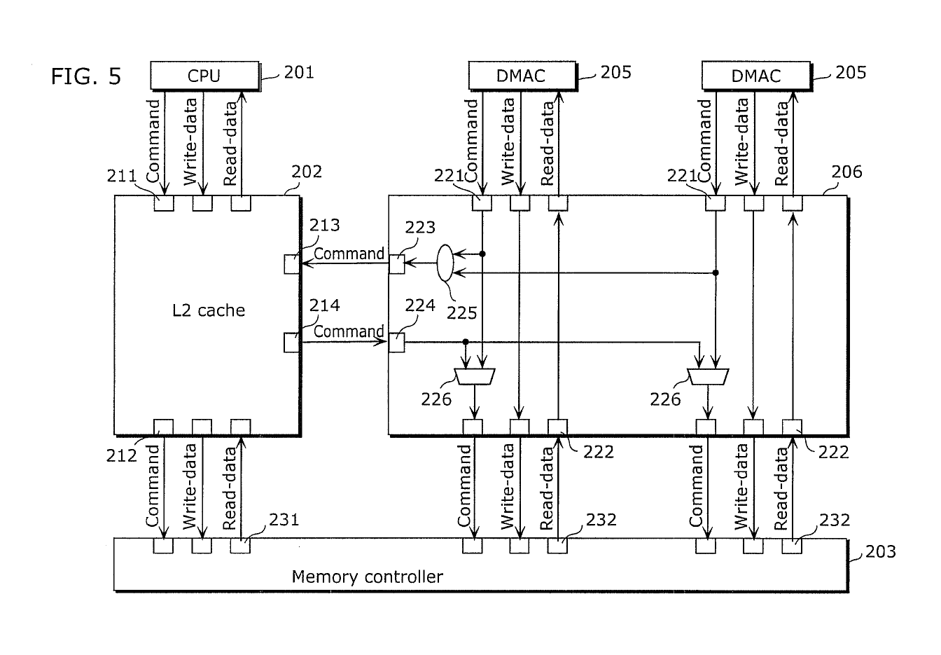

FIG. 5 illustrates the configuration and connection of the bus controller 206. Note that, for the simplicity of description, the following is an example including one CPU 201.

As illustrated in FIG. 5, the bus controller 206 includes two first ports 221, two second ports 222, a third port 223, a fourth port 224, an arbiter 225, and two selectors 226.

The first port 221, the second port 222, and the selector 226 are provided for each DMAC 205. The first port 221 is connected to the corresponding DMAC 205, receives a command and write-data output from the corresponding DMAC 205, and outputs the read-data to the corresponding DMAC 205.

The second port 222 is connected to the memory controller 203, and receives an input of the read data output by the memory controller 203, and outputs the command and the write-data to the memory controller 203.

The third port 223 is connected to the third port 213 in the L2 cache 202, and outputs a command to the L2 cache 202.

The fourth port 224 is connected to the fourth port 214 in the L2 cache 202, and receives an input of the command output from the L2 cache 202.

The arbiter 225 arbitrates the commands input to the first ports 221, and outputs the arbitrated command to the third port 223. More specifically, when one of the first ports 221 receives an input of a command, the arbiter 225 selects the input command, and outputs the selected command to the third port 223. Furthermore, when input of the commands are simultaneously received at the first ports 221, the arbiter 225 selects a command according to predetermined priority, and outputs the selected command to the third port 223.

The selector 226 selects one of the command input to the corresponding first port 221 and the command input to the fourth port, and outputs the selected command to the corresponding second port 222. More specifically, the selector 226 selects one of the command output by the DMAC read control unit 64 and the command output by the DMAC 205, and outputs the selected command to the memory 204. More specifically, the selector 226 selects the command input to the fourth port 224 when in regular mode, and selects the command input to the first port 221 when in bypass mode. Note that, the following description concerns the regular mode unless otherwise noted.

Here, the regular mode refers to a mode in which the DMAC 205 accesses the memory 204 through the L2 cache 202. The bypass mode refers to a mode in which the DMAC 205 directly accesses the memory 204 without passing through the L2 cache 202.

In addition, the regular mode is selected when the CPU 201 and the DMAC 205 use the data in the same address in the memory 204, and the bypass mode is selected when the DMAC 205 and the CPU 201 do not use the data in the same address, that is, when the coherency is maintained without special control. Switching between the regular mode and the bypass mode is performed by the CPU 201 and others.

In addition, when the command input to the fourth port 224 is the command output by the L2 cache 202 according to the command output from the corresponding DMAC 205 in regular mode, the selector 226 outputs the command input to the fourth port 224 to the second port 222, and when the command input to the fourth port 224 is a command output by the L2 cache 202 according to the command output by the L2 cache 202 according to the command output from a non-corresponding DMAC 205, the selector 226 does not output the command input to the fourth port 224 to the second port 222.

More specifically, the command output by the L2 cache 202 includes information indicating whether or not the command is a command output from one of the two DMACs 205. Based on the information, the selector 226 determines whether or not to output the command input to the fourth port 224 to the second port 222.

In addition, the write-data input to the first port 221 is directly output to the corresponding second port 222, and the read-data input to the second port 222 is directly output to the corresponding first port 221.

In addition, as illustrated in FIG. 5, the memory controller 203 includes a first port 231 and two second ports 232. The first port 231 corresponds to the L2 cache 202, and each of the two second ports 232 corresponds to a corresponding one of the two DMAC 205 on one to one.

The first port 231 receives input of the read-command output by the CPU read control unit 61 and the write-command and the write-data output by the CPU write control unit 62. In addition, the first port 231 outputs the read-data output from the memory 204 to the L2 cache 202. More specifically, the first port 231 is connected to the second port 212 in the L2 cache 202.

Each of the second ports 232 is provided for each of the second ports 222 in the bus controller 206, and is connected to the corresponding one of the second ports 222. Each of the second port 232 receives input from the command and write-data output from the second port 222 corresponding to the bus controller 206, and outputs the read-data from the memory 204 to the corresponding second port 222.

More specifically, in the regular mode, the second port 232 receives an input of the read-command output by the DMAC read control unit 64 and the write-command output by the DMAC write control unit 65. In addition, when in bypass mode, the second port 232 receives an input of the read-command and the write-command output by the corresponding DMAC 205. Both in regular mode and bypass mode, the second port 232 receives an input of the write data output by the corresponding DMAC 205, and outputs the read-data output from the memory 204 according to the read-command to the corresponding DMAC 205.

Here, the memory controller 203 arbitrates the command input to the first port 231 and the two second ports 232 (read-command and write-command) depending on to which of the first port 231 and the two second ports 232 the command is input. More specifically, bandwidth is allocated to each port, and the memory controller 203 performs the arbitration to satisfy the bandwidth. For example, when the bandwidth is allocated to the first port 231 and to the two second ports 232 in a ratio of 2:1:1, the memory controller 203 executes the command input to each of the second ports 232 each time the command input to the first port is executed twice.

The following describes an operation of the memory system 200 according to an embodiment of the present invention.

The following describes an operation when the DMAC 205 accesses the memory 204.

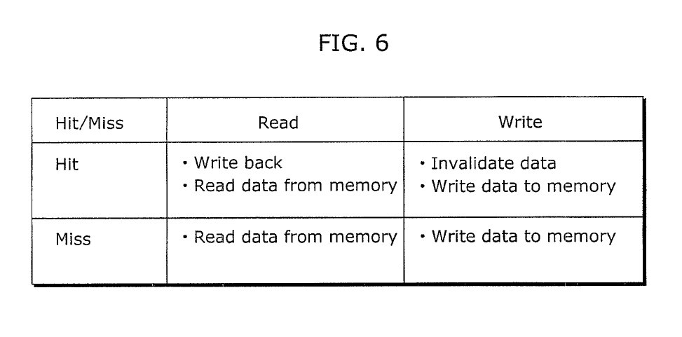

FIG. 6 illustrates an overview of the operation of the memory system 200 when the L2 cache 202 accesses the memory system 200.

As illustrated in FIG. 6, at the time of reading and hit (hereafter referred to as read-hit), the L2 cache 202 writes back the hit data. After that, the data in the memory 204 is read and sent to the DMAC 205.

Alternatively, at the time of reading and cache miss (hereafter referred to as read-miss), the data in the memory 204 is read and sent to the DMAC 205.

Alternatively, at the time of writing and hit (hereafter referred to as write-hit), the L2 cache 202 invalidates the hit data. In addition, the write-data is written on the memory 204.

Alternatively, at the time of writing and a cache miss (hereafter referred to as write-miss), the write-data is written on the memory 204.

The following describes each operation separately. First, the operation at the time of read-hit shall be described.

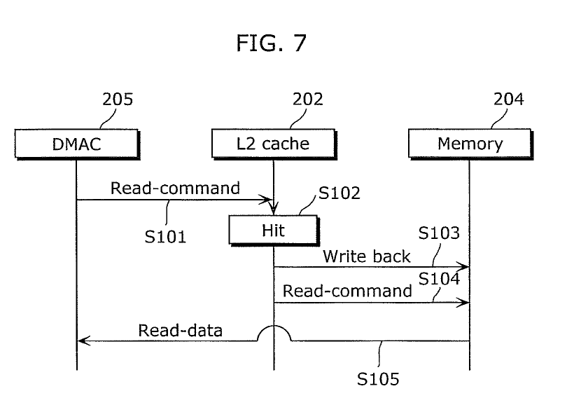

FIG. 7 illustrates a flow of the operation of the memory system 200 at the time of read-hit.

As illustrated in FIG. 7, first, the DMAC 205 outputs the read-command to the L2 cache 202 (S101). More specifically, the DMAC 205 outputs a read-command to the first port 221 of the bus control unit 206. The read-command input to the first port 221 of the bus control unit 206 is input to the third port 213 of the L2 cache 202 through the arbiter 225 and the third port 223, sequentially.

The hit determining unit 71 in the L2 cache 202 determines whether or not the data in the address specified by the read-command input to the third port 213 is stored in the cache storage unit 70. Here, the hit determining unit 71 determines that the data in the specified address is stored in the cache storage unit 70 (hit) (S102).

Next, the DMAC read control unit 64 in the L2 cache 202 writes back the hit data (S103). More specifically, the DMAC read control unit 64 writes the hit data back to the memory 204.

After the write-back is complete, the DMAC read control unit 64 outputs the read-command to the memory 204 (S104). More specifically, the DMAC read control unit 64 outputs the read-command to the fourth port 214. Note that the read-command specifies the same address as the read-command output by the DMAC 205 in step S101.

The read-command output to the fourth port 214 is input to the second port 232 of the memory controller 203 sequentially through the fourth port 224, the selector 226, and the second port 222 of the bus control unit 206. The memory controller 203 outputs the read-command input to the second port 232 to the memory 204.

The memory 204 which receives an input of the read-command, outputs the read-data stored in the address specified by the read-command directly to the DMAC 205 without passing through the L2 cache 202 (S105). More specifically, the memory 204 outputs the read-data to the memory controller 203, and the memory controller 203 outputs the read data output from the memory 204 to the second port 232 to which the read-command is input. The read data output to the second port 232 is output to the DMAC 205 sequentially through the second port 222 and the first port 221 of the bus control unit 206.

As described above, when the access from the DMAC 205 is a read-hit, the memory system 200 according to an embodiment of the present invention writes back the hit data stored in the L2 cache 202, and reads the data from the memory 204.

With this, the data in the L2 cache 202 is updated by the CPU 201. Thus, even when the data in the L2 cache 202 and the data in the memory 204 do not match, the DMAC 205 can read the correct data (the updated data). In other words, it is not necessary for the CPU 201 to instruct the L2 cache 202 to perform purging (writing-back) after writing. As such, the memory system 200 according to an embodiment of the present invention can reduce the purging by the CPU 201, thereby suppressing the reduction in the processing capacity of the CPU 201 for maintaining the coherency.

In addition, the L2 cache 202 outputs the read-command to the fourth port 214 after the write-back is complete. This prevents the data from being read from the memory 204 before the write-back is complete.

Next, the operation at the time of read-miss shall be described.

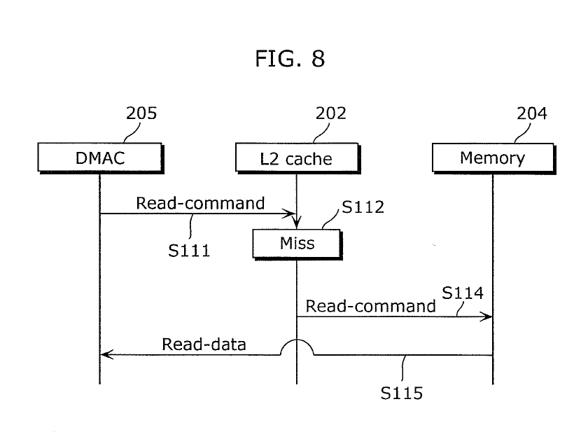

FIG. 8 illustrates a flow of the operation of the memory system 200 at the time of read-miss.

As illustrated in FIG. 8, first, the DMAC 205 outputs the read-command to the L2 cache 202 (S111). Note that, the operations in steps S111, S114, and S115 are similar to those illustrated in S101, S104 and S105 in FIG. 7, and thus the detailed description is omitted.

The hit determining unit 71 in the L2 cache 202 determines whether or not the data in the address specified by the read-command input to the third port 213 is stored in the cache storage unit 70. Here, the hit determining unit 71 determines that the data in the specified address is not stored in the cache storage unit 70 (cache miss) (5112).

Next, the DMAC read control unit 64 in L2 cache 202 outputs the read-command to the memory 204 (S114). More specifically, the DMAC read control unit 64 outputs the read-command to the fourth port 214. Note that the read-command specifies the same address as the read-command output by the DMAC 205 in step S101.

The read-command output to the fourth port 214 is input to the second port 232 of the memory controller 203 sequentially through the fourth port 224, the selector 226, and the second port 222 of the bus control unit 206. The memory controller 203 outputs the read-command input to the second port 232 to the memory 204.

The memory 204 which received an input of the read-command outputs the read-data in the address specified by the read-command to the DMAC 205 (S115).

As such, when there is a read-miss in the access from the DMAC 205, the memory system 200 according to an embodiment of the present invention reads the data from the memory 204.

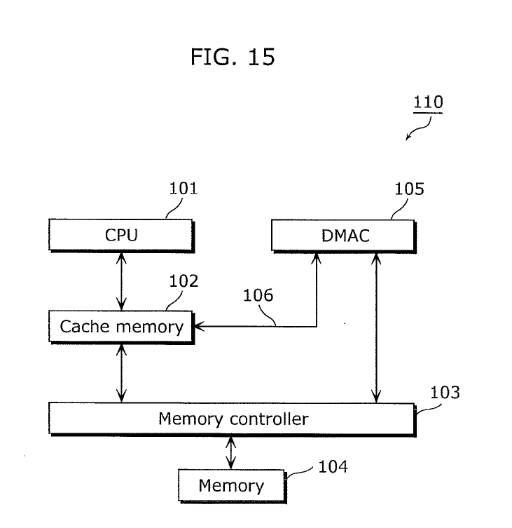

As described above, the L2 cache 202 according to an embodiment of the present invention does not output the hit data to the DMAC 205 even at the time of read-hit. More specifically, at the time of read access from the DMAC 205, the read-data output from the memory 204 is directly output to the DMAC 205 without passing the L2 cache 202, in either case of hit or cache miss. With this, a bus for transmitting the read-data is not necessary between the L2 cache 202 and the DMAC 205. More specifically, as illustrated in FIG. 5, only the read-command shall be input to the third port 213 of the L2 cache 202, and only the read-command shall be output from the third port 213. Thus, the memory system 200 according to the present invention can reduce its dimension compared to the memory system 110 illustrated in FIG. 15.

Furthermore, it is not necessary to add new control for data transmission between the DMAC 205 and the L2 cache 202, since the read-data does not pass through the L2 cache. More specifically, the present invention can prevent the interface between the DMAC 205 and the L2 cache 202 to become more complex.

In addition, the read-command that the L2 cache 202 outputs to the fourth port 214 is input to the second port 232 in the memory controller 203 corresponding to the DMAC 205 which is the source of the read-command. With this, the memory controller 203 considers that the read-command is issued by the DMAC 205. On the other hand, when the L2 cache 202 outputs the read-command to the first port 231 of the memory controller 203, the read-command is considered to be issued by the L2 cache 202 (CPU 201), and uses the bandwidth allocated to the L2 cache 202.

As such, even when the command output from the DMAC 205 is sent to the memory 204 through the L2 cache 202, inputting the command output by the DMAC read control unit 64 to the second port 232 corresponding to the DMAC 205 allows the memory controller 203 to allocate bandwidths to the CPU 201 and the DMAC 205 by a simple control including allocating the bandwidth for the CPU 201 to the first port 231 and allocating the bandwidth for the DMAC 205 to the second port 232. Furthermore, the memory system 200 according to an embodiment of the present invention can achieve the control of the memory controller 203 from a case where the DMAC 205 accesses the memory 204 without passing the L2 cache 202.

Next, the operation at the time of write-hit shall be described.

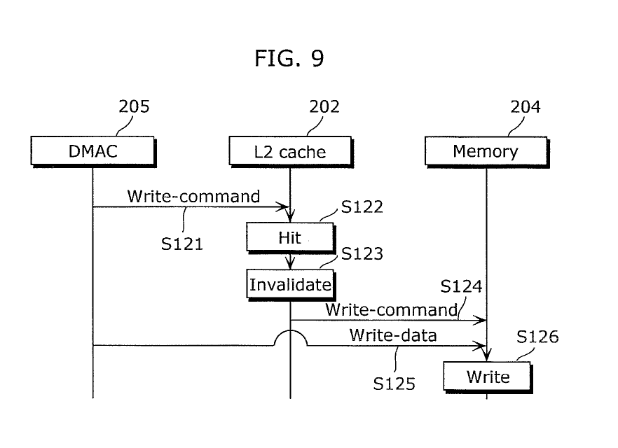

FIG. 9 illustrates a flow of the operation of the memory system 200 at the time of write-hit.

As illustrated in FIG. 9, first, the DMAC 205 outputs the write-command to the L2 cache 202 (S121). More specifically, the DMAC 205 outputs a write-command to the first port 221 of the bus control unit 206. The write-command input to the first port 221 of the bus control unit 206 is input to the third port 213 of the L2 cache 202 through the arbiter 225 and the third port 223, sequentially.

The hit determining unit 71 in the L2 cache 202 determines whether or not the data in the address specified by the write-command input to the third port 213 is stored in the cache storage unit 70. Here, the hit determining unit 71 determines that the data in the specified address is stored in the cache storage unit 70 (hit) (S122).

Next, the DMAC write-control unit 65 of the L2 cache 202 invalidates the hit data (S123). More specifically, the DMAC write control unit 65 sets the valid flag 42 of the hit data to “0”.

Next, the DMAC write control unit 65 outputs the write-command to the memory 204 (S124). More specifically, the DMAC write control unit 65 outputs the write-command to the fourth port 214. Note that the write-command specifies the same address as the write-command output by the DMAC 205 in step S121.

The write-command output to the fourth port 214 is input to the second port 232 of the memory controller 203 sequentially through the fourth port 224, the selector 226, and the second port 222 of the bus control unit 206.

On the other hand, the DMAC 205 outputs the write-data to the memory 204 without passing the L2 cache 202 (S125). More specifically, the DMAC 205 outputs the write-data to the first port 221 of the bus control unit 206. The write-data input to the first port 221 is input to the second port 232 of the memory controller 203 through the second port 222.

The memory controller 203 outputs the write-command and the write-data input to the second port 232 to the memory 204.

The memory 204 which received inputs of the write-command and the write-data stores the write-data in the address specified by the write-command (S126).

As described above, when there is a write-hit at the time of an access from the DMAC 205, the memory system 200 according to an embodiment of the present invention invalidates the hit data stored in the L2 cache 202, and writes the data on the memory 204.

With this, the writing by the DMAC 205 prevents inconsistency in the data in the L2 cache 202 and the data in the memory 204. More specifically, it is not necessary for the CPU 201 and the DMAC to add special process (purging) to maintain the coherency between the L2 cache 202 and the memory 204. As such, the memory system 200 according to an embodiment of the present invention can suppress the reduction in processing capacity of the CPU 201 for maintaining the coherency.

Next, the operation at the time of write-miss shall be described.

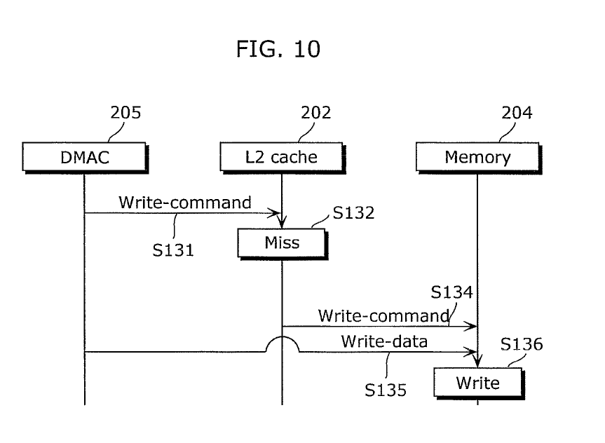

FIG. 10 illustrates a flow of the operation of the memory system 200 at the time of write-miss.

As illustrated in FIG. 10, first, the DMAC 205 outputs the write-command to the L2 cache 202 (S131). Note that, the operation in step S131 and S134 to S136 is similar to the operation in S121 and S124 to S126 illustrated in FIG. 9, and thus the detailed description shall be omitted.

The hit determining unit 71 in the L2 cache 202 determines whether or not the data in the address specified by the read-command input to the third port 213 is stored in the cache storage unit 70. Here, the hit determining unit 71 determines that the data in the specified address is not stored in the cache storage unit 70 (cache miss) (S132).

Next, the DMAC write control unit 65 of the L2 cache 202 outputs the write-command to the memory 204 (S134). More specifically, the DMAC write control unit 65 outputs the write-command to the fourth port 214. Note that the write-command specifies the same address as the read-command output by the DMAC 205 in step S101.

The write-command output to the fourth port 214 is input to the second port 232 of the memory controller 203 sequentially through the fourth port 224, the selector 226, and the second port 222 of the bus control unit 206.

The DMAC 205 outputs the write-data to the memory 204 (S135).

The memory 204 which received inputs of the write-command and the write-data stores the write-data in the address specified by the write-command (S136).

As described above, when the access from the DMAC 205 is a write-miss, the memory system 200 according to an embodiment of the present invention writes the write-data on the memory 204.

As such, the L2 cache 202 according to an embodiment of the present invention does not store the write-data even at the time of write-hit. More specifically, at the time of the write-access from the DMAC 205, the write-data output from the DMAC 205 is output to the memory 204 without passing through the L2 cache 202 in either case of hit or cache miss. With this, a bus for transmitting the write-data between the L2 cache 202 and the DMAC 205 is not necessary. More specifically, as illustrated in FIG. 5, only the write-command shall be input to the third port 213 of the L2 cache 202, and only the write-command shall be output from the third port 213. Thus, the memory system 200 according to the present invention can reduce its dimension compared to the memory system 110 illustrated in FIG. 15.

Furthermore, it is not necessary to add new control for data transmission between the DMAC 205 and the L2 cache 202, since the read-data does not pass through the L2 cache. More specifically, the present invention can prevent the interface between the DMAC 205 and the L2 cache 202 to become more complex.

Furthermore, the write-command that the L2 cache 202 outputs to the fourth port 213 is input to the second port 232 in the memory controller 203 corresponding to the DMAC 205 which is an issuing source of the write-command. With this, the memory controller 203 considers that the write-command is issued by the DMAC 205. In other words, the memory controller 203 can allocate the bandwidths to the CPU 201 and the DMAC 205 with a simple control including allocating the bandwidth for the CPU 201 to the first port 231 and allocating the bandwidth for the DMAC 205 to the second port 232, in the same manner as the processing at the time of read-access. Furthermore, the memory system 200 according to an embodiment of the present invention can achieve the control of the memory controller 203 from a case where the DMAC 205 accesses the memory 204 without passing the L2 cache 202.

The following describes a flow of the operation by the L2 cache 202.

First, the operations of the L2 cache 202 at the time of read-access shall be described.

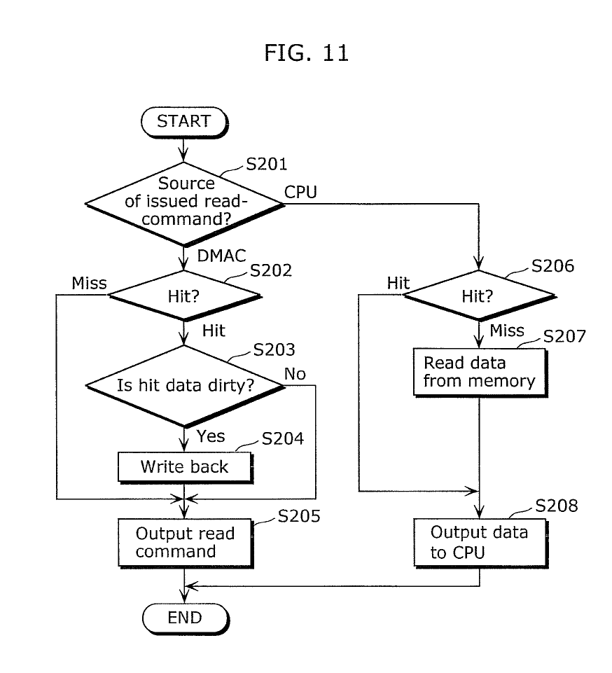

FIG. 11 is a flowchart illustrating a flow of the operations by the L2 cache 202 when receiving an input of the read-command.

As illustrated in FIG. 11, when the DMAC 205 issues the read-command, that is, when the read-command is input to the third port 213 (DMAC in S201), the hit determining unit 71 determines whether or not the data in the address specified by the read-command is stored in the cache storage unit 70 (S202).

When the data is stored (hit in S202), the DMAC read control unit 64 then determines whether or not the hit data is dirty, that is, the hit data is updated by the CPU 201 (S203). More specifically, the L2 cache 202 determines that the data is dirty when the dirty flag 43 of the hit data is “1”, and determines that the data is not dirty when the dirty flag 43 is “0”.

When the data is dirty (Yes in S203), the DMAC read control unit 64 writes back the hit data (S204).

After the completion of the write-back, the DMAC read control unit 64 outputs the read-command to the fourth port 214 (S205).

In addition, when the data is not dirty (No in S203), or when there is a cache-miss in step S202 (miss in S202), the DMAC read control unit 64 outputs the read-command to the fourth port 214 (S205) without performing the write-back (S204).

On the other hand, when the CPU 201 issues the read-command, that is, when the read-command is input to the first port 211 (CPU in S201), the hit determining unit 71 determines whether or not the data in the address specified by the read-command is stored in the cache storage unit 70 (S206).

When the data is stored (hit in S206), the CPU read control unit 61 outputs the hit data to the CPU 201 (first port 211) as the read data (S208).

On the other hand, when the data is not stored (miss in S206), the CPU read control unit 61 reads the data in the address specified by the read command from the memory 204 (S207). More specifically, the CPU read control unit 61 outputs the read command specifying the same address as the read-command input form the CPU 201 to the second port 212. The read command output to the second port 212 is output to the memory 204 through the first port 231 of the memory controller 203. The memory 204 which received the read command outputs the data stored in the address specified by the read command to the memory controller 203 as the read data. The memory controller 203 outputs, to the second port 212 of the L2 cache 202 from the first port 231, the read data output from the memory 204.

The CPU read control unit 61 stores the read data input to the second port 212 in the cache storage unit 70, and outputs the read data from the first port 211 to the CPU 201 (S208).

Next, the operation of the L2 cache 202 at the time of write-access shall be described.

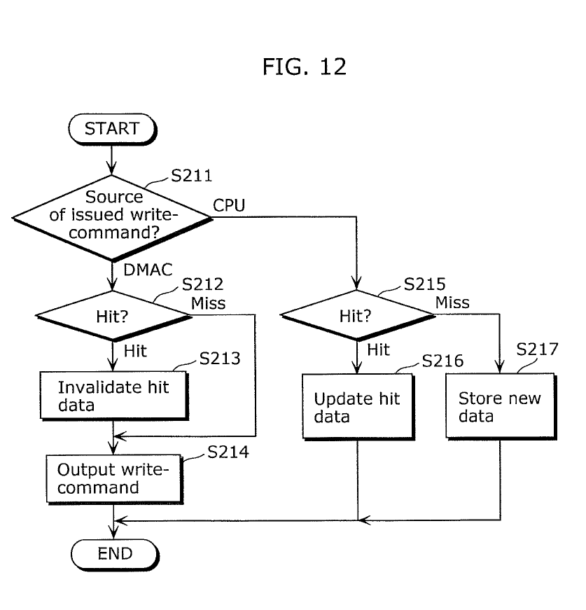

FIG. 12 is a flowchart illustrating a flow of the operations by the L2 cache 202 when receiving an input of the write-command.

As illustrated in FIG. 12, when the DMAC 205 issues the write-command, that is, when the write-command is input to the third port 213 (DMAC in S211), the hit determining unit 71 determines whether or not the data in the address specified by the write-command is stored in the cache storage unit 70 (S212).

When the data is stored (hit in S212), the L2 cache 202 then invalidates the hit data (S213). More specifically, the L2 cache 202 sets the valid flag 42 of the hit data to “0”.

The L2 cache 202 subsequently outputs the write-command to the fourth port 214 (S214).

Alternatively, in the case of cache miss in step S212 (miss in S212), the L2 cache 202 outputs the write-command to the fourth port 214 (S214) without invalidating the data (S213).

On the other hand, when the CPU 201 issues the write-command, that is, when the write-command and the write-data is input to the first port 211 (CPU in S211), the hit determining unit 71 determines whether or not the data in the address specified by the write-command is stored in the cache storage unit 70 (S215).

When the data is stored (hit in S215), the CPU write control unit 62 updates the hit data to the write-data input to the first port (S216). More specifically, the CPU write control unit 62 changes the hit data to the write data, and sets the dirty flag 43.

When the data is not stored (miss in S215), the CPU write control unit 62 performs line replacement. More specifically, the CPU write control unit 62 selects a new cache entry 40, and stores the write-data input to the first port in the selected cache entry 40 (S217). The CPU write control unit 62 also sets the dirty flag of the write-data.

As described above, at the time of read-hit of the access from the DMAC 205, the memory system 200 according to an embodiment of the present invention writes back the hit data stored in the L2 cache 202, and reads the data from the memory 204.

With this, the data in the L2 cache 202 is updated by the CPU 201. Thus, even when the data in the L2 cache 202 and the data in the memory 204 do not match, the DMAC 205 can read the correct data (the updated data). In other words, it is not necessary for the CPU 201 to instruct the L2 cache 202 to perform purging (writing-back) after writing. As such, the memory system 200 according to an embodiment of the present invention can reduce the purging by the CPU 201, thereby suppressing the reduction in the processing capacity of the CPU 201 for maintaining the coherency.

As described above, when there is a write-hit at the time of an access from the DMAC 205, the memory system 200 according to an embodiment of the present invention invalidates the hit data stored in the L2 cache 202, and writes the data on the memory 204.

This prevents inconsistency in the data in the L2 cache 202 and the data in the memory 204 caused by the writing by the DMAC 205. More specifically, it is not necessary for the CPU 201 and the DMAC 205 to add special process (purging) to maintain the coherency between the L2 cache 202 and the memory 204. As such, the memory system 200 according to an embodiment of the present invention can suppress the reduction in processing capacity of the CPU 201 for maintaining the coherency.

Furthermore, in the memory system 200 according to an embodiment of the present invention, the L2 cache 202 does not output the data stored by the L2 cache 202 even when the read access from the DMAC 205 is a hit. In addition, the L2 cache 202 does not store the write-data output from the DMAC 205 even when the write-access from the DMAC 205 is a hit.

Thus, a bus for transmitting the data between the L2 cache 202 and the DMAC 205 is not necessary. Thus, the memory system 200 according to the present invention can reduce its dimension compared to the memory system 110 illustrated in FIG. 15. Furthermore, it is not necessary to add new control for data transmission between the DMAC 205 and the L2 cache 202, since the read-data and the write-data do not pass through the L2 cache. More specifically, the present invention can prevent the interface between the DMAC 205 and the L2 cache 202 to become more complex.

Furthermore, in the memory system 200 according to an embodiment of the present invention, the command that the L2 cache 202 outputs to the fourth port 213 is input to the second port 232 of the memory controller 203 corresponding to the DMAC 205 which is the issuing source of the command. With this, the memory controller 203 considers that the write-command is issued by the DMAC 205. In other words, the memory system 200 according to an embodiment of the present invention can achieve the control of the memory controller 203 from a case where the DMAC 205 accesses the memory 204 without passing the L2 cache 202. In addition, the control of allocation of the bandwidths to the masters (the CPU 201 and the DMAC 205) upon the access to the memory 204 can easily be achieved.

Note that, the complexity of the interface described above is particularly problematic when more than one bus protocols are used between an external master such as the DMAC 205 and the memory 204. In other words, the memory system 200 according to an embodiment of the present invention is particularly effective when more than one bus protocols are used between the external master such as the DMAC 205 and the memory 204.

For example, in the memory system using a ring bus, more than one bus protocol is used between the external master such as the

DMAC 205 and the memory 204. Thus, the present invention is particularly effective.

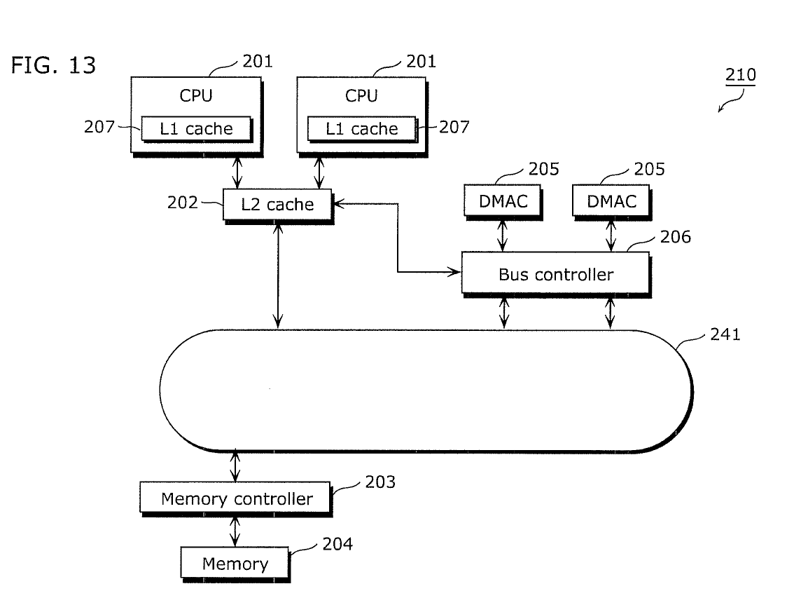

FIG. 13 is a variation of the memory system 200 according to an embodiment of the present invention, and illustrates a configuration of the memory system 210 using a ring bus. As illustrated in FIG. 13, the memory system 210 includes a ring bus 241. Note that, the components similar to those in FIG. 1 are assigned with the same reference numerals, and the detailed description for those components is omitted. The L2 cache 202, the bus control unit 206 and the memory controller 203 are connected through the ring bus 241.

The above description describes cache memory according to the embodiment of the present invention. However, the present invention is not limited to the embodiment.

For example, in the description above, an example of the memory system including the L2 cache 202 and the L2 cache is described. However, the present invention may be applied to a memory system including an L1 cache only.

Note that, when the memory system includes the level 1 cache and level 2 cache, the present invention shall preferably be applied to the level 2 cache. This is because the effect of the level 2 caches to the entire memory system is relatively small compared to level 1 caches. More specifically, the access at the time of hit in the level 1 cache is the fastest access for the processor. This, the access from the master to the level 1 cache has an adverse effect on the access by the processor to the level 1 cache, which is most effective for accelerating the access. Thus, applying the cache memory according to an aspect of the present invention to the level 2 cache reduces the adverse effect on the acceleration of the processor, compared to a case where the cache memory according to as aspect of the present invention is applied to the level 1 cache.

Furthermore, the present invention may be applied to the memory system with level 3 cache or more. In this case, for the reason described above, it is preferable to apply the cache memory according to the present invention to the largest level.

In addition, two CPUs 201 and two DMACs 205 are illustrated in FIG. 1. However, the number of the CPU 201 and the DMAC 205 may be one, or three or more. Furthermore, a master other than the DMAC 205 may also be included.

Note that, as illustrated in FIG. 1, applying the cache memory according to an aspect of the present invention to the L2 cache 202 shared by more than one CPUs 201 each of which includes a L1 cache 207 is particularly suitable.

When the L2 cache 202 is shared by more than one CPUs 201 each of which includes an L1 cache 207, the CPUs 201 perform control based on an algorithm such as cache snooping to maintain coherency between the L1 caches 207 and the shared L2 cache 202. Thus, in addition to the control, adding the control for maintaining the coherency between the L2 cache 202 and the memory 204 would make the control even more complex, and makes the implementation difficult. In contrast, applying the cache memory according to an aspect of the present invention to the L2 cache 202 reduces the process (purging) for maintaining the coherency between the L2 cache 202 and the memory 204, preventing the control to be complex. As described above, the cache memory according to an aspect of the present invention is particularly suitable for an application to the L2 cache 202 shared by more than one CPUs 201 each of which includes an L1 cache 207.

Furthermore, the description is made using a cache memory having 4-way set associative L2 cache 202. However, the number of ways 31 may be other than four.

Furthermore, the present invention is also applicable to a full-associative cache memory or direct-mapping cache memory.

### INDUSTRIAL APPLICABILITY

The present invention is applicable to a cache memory and a memory system which includes a cache memory.

What is claimed is:

1. A cache memory which stores part of data stored in a main memory according to an access from a processor, said cache memory comprising:
a first port for input of a command from the processor;
a second port for input of a command from a master other than the processor;
a hit determining unit configured, when a command is input to said first port or said second port, to determine whether or not data corresponding to an address specified by the command is stored in said cache memory; and
a first control unit configured to perform a process for maintaining coherency of the data stored in the cache memory and corresponding to the address specified by the command and data stored in the main memory, and to output the input command to the main memory as a command output from the master, when the command is input to the second port and said hit determining unit determines that the data is stored in said cache memory.

2. The cache memory according to claim 1,
wherein said first control unit includes
a first read control unit configured, when a read-command is input to said second port as the command, said hit determining unit determines that the data is stored, and the data stored in the cache memory is dirty, to write the data back to the main memory, and to output the input read-command to the main memory as a read-command output from the master, after the write-back is complete.

3. The cache memory according to claim 1,
wherein, when the read-command is input to the second port and said hit determining unit determines that the data is not stored, said first read control unit is configured to output the input read-command to the main memory as a read-command output from the master.

4. A memory system comprising the following elements according to claim 2:
said cache memory;
the processor;
the master; and
the main memory,
wherein said main memory outputs the data stored in the address specified by the read-command output from said first read control unit to said master without passing said cache memory.

5. The memory system according to claim 4,
wherein said cache memory further includes
a second read control unit configured, (i) when the read-command is input to said first port and said hit determining unit determines that the data is stored, to output the data stored in said cache memory corresponding to the address specified by the read-command to said processor, and (ii) when the read-command is input to said first port and said hit determining unit determines that the data is not stored, to read the data from said main memory in the address specified by the read-command, to store the read data in said cache memory, and to output the data to said processor.

6. The memory system according to claim 5, further comprising
a memory controller which arbitrates between an access from said cache memory to said main memory and an access from said master to said main memory,
wherein said memory controller includes:
a third port for input of the read-command output from said first read control unit, and for an output of the read-data output from said main memory according to the read-command to said master; and
a fourth port for input of the read-command output from said second read control unit, and for an output of the read-data output from said main memory according to the read-command to said cache memory, and
said memory controller arbitrates between the read-command input to said third port and the read-command input to said fourth port, according to whether the read-command is input to said third port or said fourth port.

7. The memory system according to claim 4, further comprising
a selector which selects one of the read-command output by said first read control unit and the read-command output by said master, and outputs the selected read-command to said main memory,
wherein said main memory outputs the data stored in the address specified by the read-command output by said selector to said master without passing said cache memory.

8. The cache memory according to claim 1,
wherein said first control unit includes
a first write control unit configured, when a write-command is input to said second port as the command and said hit determining unit determines that the data is stored, to invalidate the data stored in said cache memory and corresponding to the address specified by the write-command, and to output the input write-command to said main memory as a write-command output from said master.

9. The cache memory according to claim 8,
wherein said first write control unit is configured, when the write-command is input to said second port and said hit determining unit determines that the data is not stored, to output the input write-command to said main memory as a write-command output from said master.

10. A memory system comprising the following elements according to claim 8:
said cache memory;
the processor;
the master; and
the main memory,
wherein said master outputs write-data to said main memory without passing said cache memory, and
said main memory stores the write-data output by said master in the address specified by the write-command output by said first write control unit.

11. The memory system according to claim 10,
wherein said cache memory further includes
a second write control unit configured, when the write-command and the write-data are input to the first port and said hit determining unit determines that the data is stored, to update the data stored in said cache memory corresponding to the address specified by the write-command to the write-data, and
said second write control unit is configured to output a write-command and write-data for writing the updated data back to said main memory.

12. The memory system according to claim 11, further comprising
a memory controller which arbitrates between an access from said cache memory to said main memory and an access from said master to said main memory,
wherein said memory controller includes:
a third port for input of the write-command output by said first write control unit and the write-data output by said master; and
a fourth port for input of the write-command and the write-data output by said second write control unit, and
said memory controller arbitrates between the write-command input to said third port and the write-command input to said fourth port, according to whether the write-command is input to said third port or said fourth port.

13. The memory system according to claim 10, further comprising
a selector which selects one of the write-command output by said first write control unit and the write-command output by said master, and outputs the selected write-command to said main memory,
wherein said main memory stores the write-data output by said master in the address specified by the write-command output by said selector.

14. The memory system according to claim 4,
wherein said processor includes a level 1 cache, and
said cache memory is a level 2 cache.

15. The memory system according to claim 14, further comprising
a plurality of processors including said processor,
wherein each of said plurality of processors includes a level 1 cache, and
said cache memory is shared by said plurality of processors.

16. A method of controlling a cache memory which stores part of data stored in a main memory according to an access from a processor, the cache memory including a first port for input of a command from the processor and a second port for input of a command from a master other than the processor, said method comprising:
determining whether or not data corresponding to an address specified by the command is stored in the cache memory, when a command is input to the first port or the second port; and
performing a process for maintaining coherency of the data stored in the cache memory corresponding to the address specified by the command and data stored in the main memory, and outputting the input command to the main memory as a command output from the master, when the command is input to the second port and said determining determines that the data is stored in said cache memory.
